(19) United States
(12) Patent Application Publication
(10) Pub. No.: US 2025/0120868 A1
(43) Pub. Date: Apr. 17, 2025

(54) MASSAGE CHAIR

(71) Applicant: SHANDONG KANGTAI INDUSTRY CO., LTD, Yantai, Shandong (CN)

(72) Inventors: Zheng KANG, Yantai, Shandong (CN); Zheyi LI, Yantai, Shandong (CN); Jincheng ZHANG, Yantai, Shandong (CN); Yigang NING, Yantai, Shandong (CN); Chongli ZHANG, Yantai, Shandong (CN)

(73) Assignee: SHANDONG KANGTAI INDUSTRY CO., LTD, Yantai, Shandong (CN)

(21) Appl. No.: 18/562,291

(22) PCT Filed: Jul. 6, 2021
(86) PCT No.: PCT/CN2021/104617

§ 371 Date: Nov. 18, 2023

(30) Foreign Application Priority Data
May 18, 2021 (CN) 202110539551.5
May 18, 2021 (CN) 202121061456.0

(51) Int. Cl. A61H 1/00

(52) U.S. Cl. CPC A61H 1/00; A61H 2201/0107; A61H 2201/0149; A61H 2201/0161

(57) ABSTRACT

A massage chair is provided, comprising a body and side plates, the side plates being connected to the body by means of swing rod mechanisms so as to expand the space on two sides of the body by moving from outside to behind relative to the body. The massage chair also comprises limiting mechanisms, the limiting mechanisms being arranged between the body and the swing rod mechanisms, or between the side plates and the swing rod mechanisms. When the swing rod mechanisms are driven by the side plates to switch between different swing states, the limiting mechanisms are correspondingly driven to switch between different limiting states, so as to enable the swing rod mechanisms to correspondingly maintain different swing states.

The present disclosure claims priority to Chinese Patent Disclosure No. 202110539551.5, titled “MASSAGE CHAIR”, filed on May 18, 2021, and Chinese Patent Disclosure No. 202121061456.0, titled “MASSAGE CHAIR”, filed on May 18, 2021 with the China National Intellectual Property Administration, both of which are incorporated herein by reference in their entireties.

### FIELD

The present disclosure relates to the technical field of massage devices, and in particular to a massage chair.

### BACKGROUND

In general, a massage chair includes a body and a side panel. The body includes a rack for activation of a massage movement mechanism, and the side panel usually includes a massage cushion that massages arms of a user. In order to facilitate the user to be seated and leave or adapt to massage requirements of users with different physiques, some massage chairs are designed to allow the side panel to be movable relative to the body, for example, solutions disclosed by Chinese Patent Disclosures CN201620242597.5, CN201721262945.6, and CN201520118119.9. These solutions can achieve the purpose of extending the lateral space of the body. The present disclosure aims to provide a solution different from the conventional technology.

### SUMMARY

The technical problem to be solved by the present disclosure is to provide a solution for extending the lateral space of a massage chair.

In order to achieve the above object, the technical solutions adopted by the present disclosure are as follows: a massage chair includes a body and a side panel, and the side panel is connected to the body by a swing bar mechanism, so that the side panel (2) is able to move relative to the body (1) by moving outward first and then moving backward to expand a space on both sides of the body. The massage chair further includes a limiting mechanism, and the limiting mechanism is arranged between the body and the swing bar mechanism or between the side panel and the swing bar mechanism. When the swing bar mechanism is driven by the side panel to switch between different swing states, the limiting mechanism is correspondingly driven to switch between different limiting states, so as to maintain the swing bar mechanism in the different swing states.

In an embodiment, the swing bar mechanism includes a first curved bar and a second curved bar. The first curved bar is located above a rear side of the second curved bar, two ends of the first curved bar are connected to the body and the side panel, respectively, and two ends of the second curved bar are respectively connected to the body and the side panel. Pivot axes of the two end portions of the first curved bar are parallel to pivot axes of the two end portions of the second curved bar.

In an embodiment, the limiting mechanism is arranged between the body and the swing bar mechanism. The limiting mechanism includes a limiting member and a sliding member. The limiting member is pivotally connected to the body, and a pivot axis of the limiting member is parallel to the pivot axes of the two end portions of the first curved bar and the pivot axes of the two end portions of the second curved bar. The sliding member is connected to the first curved bar or second curved bar. The limiting member has a limiting groove in sliding fit with the sliding member. The limiting groove is provided with multiple limiting groove segments arranged at intervals in a length direction of the limiting groove, and a transition groove segment is formed between two adjacent limiting groove segments. A groove rabbet size of the limiting groove segment matches with a radial size of the sliding member. A groove rabbet size of the transitional groove segment is less than the radial size of the sliding member. The limiting mechanism is configured to be in different limiting states by the sliding member being slide to different limiting groove segments of the limiting groove.

In an embodiment, the sliding member is rotatably connected to the first curved bar or the second curved bar, and a rotational axis of the sliding member is parallel to the pivot axis of the limiting member.

In an embodiment, at least one of a groove wall of the limiting groove and an outer peripheral wall of the sliding member is in an elastic deformable structure.

In an embodiment, the sliding member is a shaft sleeve rotatably sleeved on a pivot shaft, and the pivot shaft is connected to the first curved bar or the second curved bar through a connecting member.

In an embodiment, a wear-resistant gasket is fitted between the limiting member and the connecting member, and the wear-resistant gasket is sleeved on the pivot shaft.

In an embodiment, A is defined as a rotation axis of relative rotation of the body and the first curved bar, B is defined as a rotation axis of relative rotation of the side panel and the first curved bar, C is defined as a rotation axis of relative rotation of the side panel and the second curved bar, D is defined as a rotation axis of relative rotation of the body and the second curved bar, and L is defined as a distance between the rotation axes. L_{AD}+L_{CD}>L_{BC}+L_{AB}.

In an embodiment, L_{CD}>L_{AB}, L_{BC}>L_{AD}, and at an initial position, an included angle between DA and DC is greater than 175 degrees, and an included angle between BA and BC is less than 175 degrees.

In an embodiment, in a process of the side panel swinging backward after being moved outward from the initial position, a rotation angle of the rotation axis B is greater than a rotation angle of the rotation axis C. When the side panel swinging backward to a rearmost positon, the rotation axis B is closer to the body 1 than the rotation axis C.

Since the above technical solutions are adopted, the present disclosure has the following beneficial effects: according to the massage chair of the present disclosure, the swing bar mechanism moves while synchronously drives the limiting mechanism to move. When the swing bar mechanism is in the different swing states, the limiting mechanism is correspondingly switched to the different limiting states, and the swing bar mechanism can be correspondingly maintained in the different swing states, so that the side panel can be kept at different positions relative to the body.

### BRIEF DESCRIPTION OF THE DRAWINGS

In order to more clearly illustrate the technical solutions of the embodiments of the present disclosure, the drawings of the embodiments are briefly introduced below. Apparently, the drawings in the following description only involve some of the embodiments of the present disclosure, but do not limit the present disclosure.

FIG. 1 illustrates a schematic view of a massage chair according to an embodiment;

FIG. 2 illustrates a state-changing view of a massage chair according to an embodiment;

FIGS. 3A to 3C illustrate schematic views of a side panel, a mounting rack of a body, a swing bar mechanism, and a limiting mechanism in an assembled state, a first exploded state, and a second exploded state, respectively;

FIG. 4A shows a change view of a limiting mechanism and a first curved bar changing from a first exploded state to a second exploded state;

FIG. 4B shows a change view of a limiting mechanism and a first curved bar changing from a second exploded state to an assembled state;

FIG. 5 illustrates a schematic view of a limiting member and a sliding member;

FIG. 6A illustrates a schematic view of a side panel relative to a mounting rack of a body at an initial position;

FIG. 6B illustrates a schematic view of FIG. 6A without showing the side panel;

FIG. 7A illustrates a schematic view of a side panel relative to a mounting rack of a body at a first swing position;

FIG. 7B illustrates a schematic view of FIG. 7A without showing the side panel;

FIG. 8A illustrates a schematic view of a side panel relative to a mounting rack of a body at a second swing position;

FIG. 8B illustrates a schematic view of FIG. 8A without showing the side panel;

FIG. 9 shows a schematic view of position changes of a side panel, a swing bar mechanism, and a limiting mechanism at different positions; and

FIG. 10 illustrates a schematic view corresponding to FIG. 9.

### DETAILED DESCRIPTION OF EMBODIMENTS

In order to clarify the purpose, technical solutions, and advantages of the embodiments of the present disclosure, the present disclosure is further described in detail below with reference to the drawings. In general, the components of the embodiments of the present disclosure described and illustrated in the drawings herein may be arranged and designed in various different configurations. All other embodiments obtained by those skilled in the art based on the embodiments of the present disclosure without creative effort fall within the protection scope of the present disclosure.

Some of the embodiments of the present disclosure will be described in detail below with reference to the drawings. Features in the embodiments described below may be combined with each other without conflict.

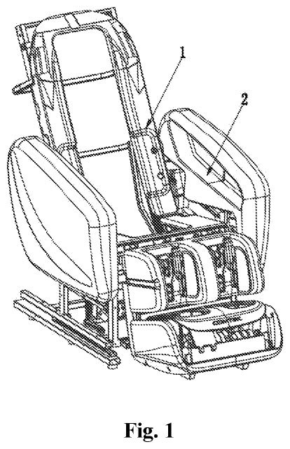

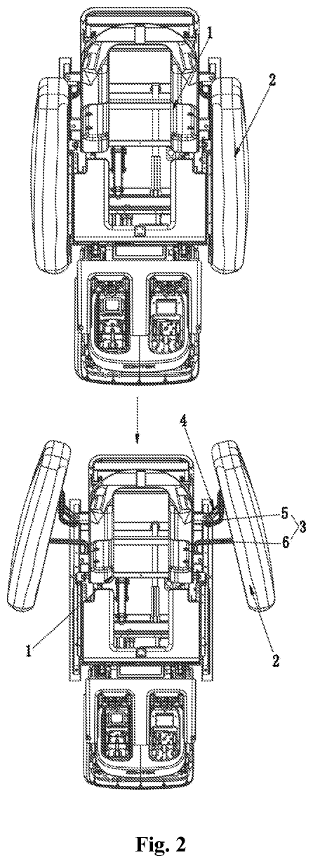

Referring to FIGS. 1 and 2, in an embodiment, a massage chair according to the present disclosure includes a body 1, a side panel 2, a swing bar mechanism 3, and a limiting mechanism 4. The side panel 2 is connected to the body 1 by the swing bar mechanism 3, so that a space on both sides of the body 1 can be extended by a movement of the side panel 2 of being moved outward and then being moved backward relative to the body 1.

A front side of the body 1 may be pivotally connected to a lower limb massage device. In the embodiment, the side panels 2 on both sides of the body 1 are movable relative to the body 1, or only one of side panels 2 is allowed to move relative to the body 1. The body 1 has a mounting rack 1A connected to the swing bar mechanism 3. The mounting rack 1A includes a guide rail for the movement of a movement mechanism for massage.

An accommodating groove for accommodating a hand is formed on an inner side of the side panel 2. A massage cushion may be provided in the accommodating groove (not shown in the figures).

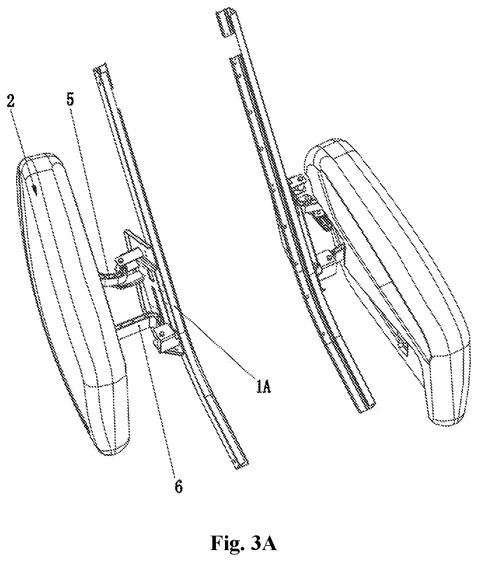

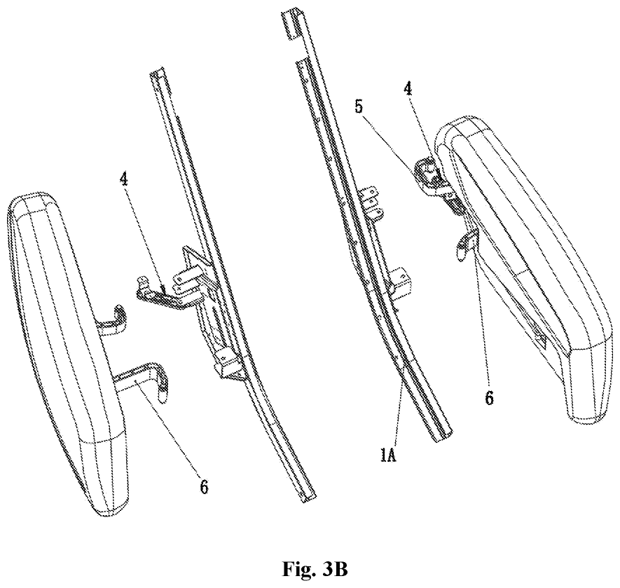

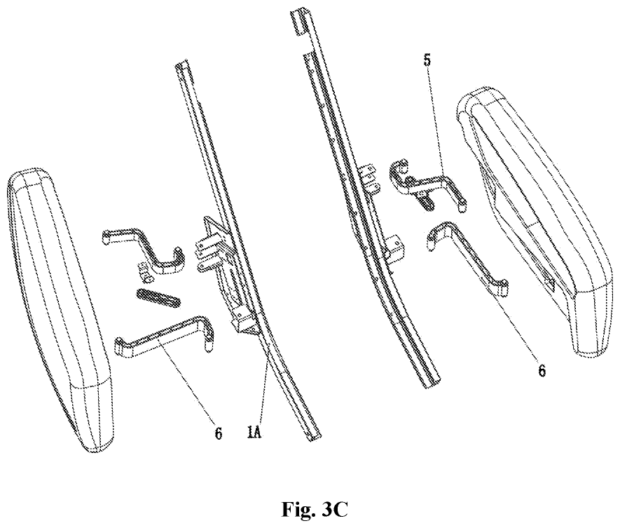

Referring to FIGS. 3A to 3C, the swing bar mechanism 3 includes a first curved bar 5 and a second curved bar 6. The first curved bar 5 is located above a rear side of the second curved bar 6. Two end portions of the first curved bar 5 are respectively pivotally connected to the mounting rack 1A of the body 1 and the side panel 2. Two end portions of the second curved bar 6 are respectively pivotally connected to the mounting rack 1A of the body 1 and the side panel 2. Pivot axes of the two end portions of the first curved bar 5 are parallel to pivot axes of the two end portions of the second curved bar 6.

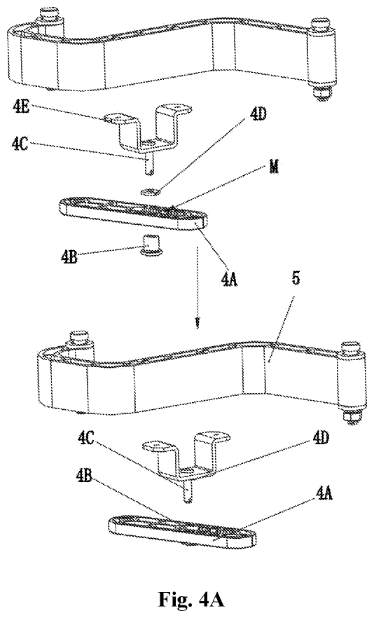

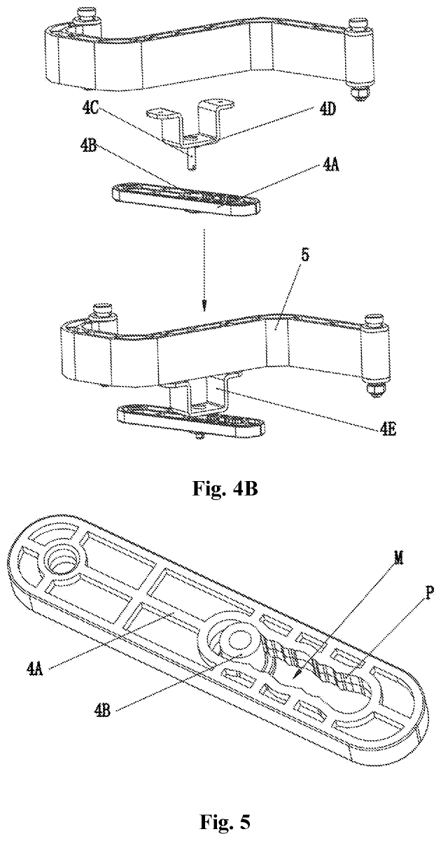

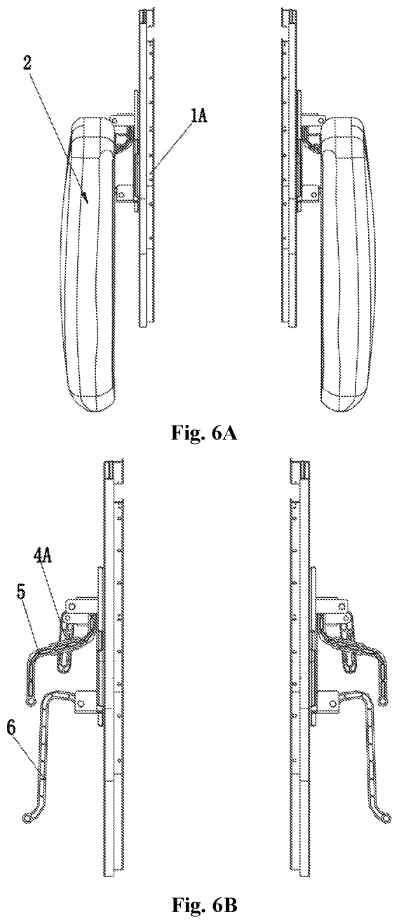

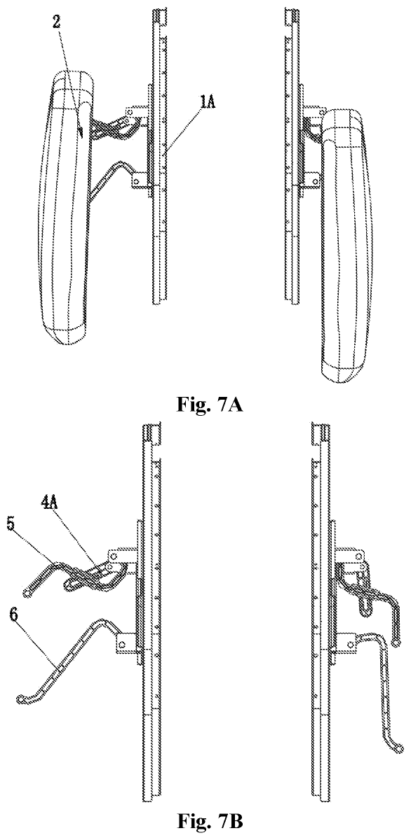

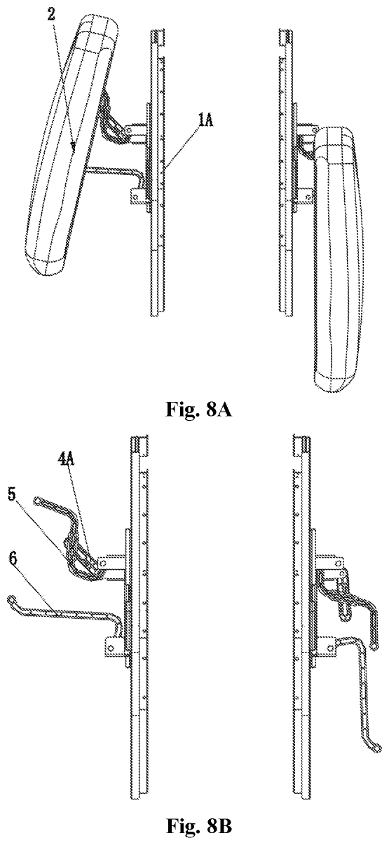

In this embodiment, the limiting mechanism 4 is arranged between the body 1 and the swing bar mechanism 3. Referring to FIGS. 6A to 8B, when the swing bar mechanism 3 is driven by the side panel 2 to switch between different swing states (FIG. 7B shows a first swing state and FIG. 8B shows a second swing state), the limiting mechanism 4 is accordingly driven to switch between different limiting states (FIG. 7B shows a first limiting state and FIG. 8B shows a second limiting state), so that the swing bar mechanism 3 is maintained under different swing states. Referring to FIGS. 4A to 5, in this embodiment, the limiting mechanism 4 includes a limiting member 4A, a sliding member 4B, a pivot shaft 4C, a wear-resistant gasket 4D, and a connecting member 4E. Referring to FIG. 3B, the limiting member 4A is pivotally connected to the mounting rack 1A of the body 1. A pivot axis of the limiting member 4A is parallel to the pivot axes of the two end portions of the first curved bar 5 and the pivot axes of the two end portions of the second curved bar 6. The sliding member 4B is rotatably connected to the first curved bar 5 through the pivot shaft 4C and the connecting member 4E. A rotation axis of the sliding member 4B is parallel to the pivot axis of the limiting member 4A. The connecting member 4E is in the shape of U and is fixed to the first curved bar 5 through connecting lugs on both sides. The pivot shaft 4C is a T-shaped pivot shaft and passes through the connecting member 4E from top to bottom, so that the pivot shaft 4C is indirectly connected to the first curved bar 5. The sliding member 4B is a shaft sleeve rotatably sleeved on the pivot shaft 4C. The wear-resistant gasket 4D is sleeved on the pivot shaft 4C. The wear-resistant gasket 4D is arranged between the limiting member 4A and the connecting member 4E. Referring to FIG. 5, the limiting member 4A has a limiting groove M, which is in sliding fit with the sliding member 4B. A groove wall P of the limiting groove M is concave-convex, so that the limiting groove M has multiple limiting groove segments arranged at intervals along a length direction of the limiting groove M. A transition groove segment is provided between adjacent limiting groove segments. A groove rabbet size of the limiting groove segment matches with a radial size of the sliding member 4B, and a groove rabbet size of the transition groove segment is less than the radial size of the sliding member 4B. The limiting mechanism 4 can be positioned in different limiting states by sliding to different limiting groove segments of the limiting groove M. When the side panel 2 in the initial state is gradually driven to move outward and then move backward, the sliding member 4B correspondingly slides along the length direction of the limiting groove M so as to be sequentially kept into different limiting groove segments. During that process, as the sliding member 4B passes through the different transition groove segments, the user can feel that the force applied to the side panel 2 varies. At least one of the groove wall P of the limiting groove M and an outer peripheral wall of the sliding member 4B may be in an elastic deformable structure. For example, the sliding member 4B is completely made of a rubber material. Compared with the rigid fit between the groove wall P and the sliding member 4B, which may bring problems, such as excessive sliding resistance, severe wear, and abnormal noise, these problems can be avoided by using the elastic deformable structure.

In other embodiments, the limiting mechanism 4 may also be arranged between the side panel 2 and the swing bar mechanism 3. The sliding member 4B may also be configured to be rotatably connected to the second curved bar 6.

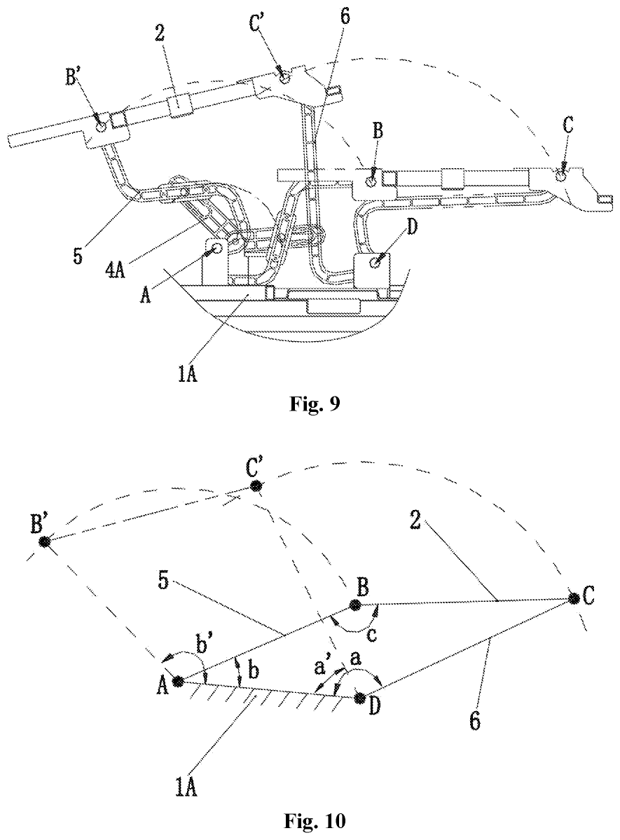

Referring to FIGS. 9 and 10, the mounting rack 1A of the body 1, the first curved bar 5, the second curved bar 6, and the side panel 2 cooperate to form a four-bar linkage, so that the side panel 2 can move outward and then move backward when being driven. A represents a rotation axis of the body 1 relative to the first curved bar 5, B represents a rotation axis of the side panel 2 relative to the first curved bar 5, C represents a rotation axis of the side panel 2 relative to the second curved bar 6, and D represents a rotation axis of the body 1 relative to the second curved bar 6. In addition, L represents a distance between the rotation axes. In a plane perspective of FIG. 10, A, B, C, and D are shown in shape of dot. B′ and C′ represent varied positions of B and C, and a, b, and c represent included angles. Specifically, a represents an included angle between DA and DC, c represents an included angle between BA and BC, and a′ and b′ represent corresponding included angles after angles of a and b are changed. In the four-bar linkage, L_{AD}+L_{CD}>L_{BC}+L_{AB}. L represents the distance between different rotation axes in the plane sense of FIG. 10, and a, b, and c also represent the included angles between the three rotation axes on the plane of FIG. 10. At the initial position, ∠c<175°, and ∠a>175°, so that the side panel 2 can be driven to move backwards by a force oriented from being outward from a side to being a directly backward. In the four-bar linkage, L_{CD}>L_{AB}, and L_{BC}>L_{AD}. In a process of the side panel swinging backward from the initial position, a rotation angle of the rotation axis B is greater than a rotation angle of the rotation axis C, so that the whole side panel 2 moves outward first when the side panel 2 is to move from the initial position to avoid parts on the rear side of the side panel 2, and then the whole side panel 2 swings. Referring to FIG. 9 and FIG. 10, when the side panel 2 swings backward to a rearmost positon after being moved outside, the rotation axis B is closer to the body 1 than the rotation axis C, and thus a front end of the side panel 2 is swung to a wider position, which is more easy for the users to be seated on and leave the massage chair.

According to the massage chair of the present disclosure, the swing bar mechanism 3 moves while synchronously drives the limiting mechanism 4 to move. When the swing bar mechanism 3 is in different swing states, the limiting mechanism 4 correspondingly switches to different limiting states, and thus the swing bar mechanism 3 can be maintained in different swing states, so that the side panel can be kept at different positions relative to the body.

The above is only specific embodiments of the present disclosure, and the protection scope of the present disclosure is not limited thereto. Any change or replacement that can be easily conceived by those skilled in the art within the technical scope disclosed in the present disclosure shall fall within the protection scope of the present disclosure. Therefore, the protection scope of the present disclosure should be determined by the protection scope of the claims.

1. A massage chair, comprising a body and a side panel, wherein the side panel is connected to the body by a swing bar mechanism, the side panel is moveable relative to the body by moving outward first and then moving backward to expand a space on both sides of the body, wherein the massage chair further comprises a limiting mechanism, which is arranged between the body and the swing bar mechanism or between the side panel and the swing bar mechanism, wherein the swing bar mechanism is driven by the side panel to switch between different swing states, and the limiting mechanism is correspondingly driven to switch between different limiting states, so as to maintain the swing bar mechanism in the different swing states.

2. The massage chair according to claim 1, wherein the swing bar mechanism comprises a first curved bar and a second curved bar, the first curved bar is located above a rear side of the second curved bar, two end portions of the first curved bar are pivotally connected to the body and the side panel, respectively, two end portions of the second curved bar are pivotally connected to the body and the side panel, respectively, and pivot axes of the two end portions of the first curved bar are parallel to pivot axes of the two end portions of the second curved bar.

3. The massage chair according to claim 2, wherein the limiting mechanism is arranged between the body and the swing bar mechanism, the limiting mechanism comprises a limiting member and a sliding member, the limiting member is pivotally connected to the body, a pivot axis of the limiting member is parallel to the pivot axes of the two end portions of the first curved bar and the pivot axes of the two end portions of the second curved bar, the sliding member is connected to the first curved bar or to the second curved bar, and the limiting member has a limiting groove in sliding fit with the sliding member,
wherein the limiting groove is provided with a plurality of limiting groove segments arranged at intervals in a length direction of the limiting groove, a transition groove segment is formed between two adjacent limiting groove segments, a groove rabbet size of each of the plurality of limiting groove segment matches with a radial size of the sliding member, a groove rabbet size of the transition groove segment is less than the radial size of the sliding member, and the limiting mechanism is configured to be in different limiting states by the sliding member being slide into different limiting groove segments of the limiting groove.

4. The massage chair according to claim 3, wherein the sliding member is rotatably connected to the first curved bar or to the second curved bar, and a rotation axis of the sliding member is parallel to the pivot axis of the limiting member.

5. The massage chair according to claim 3, wherein at least one of a groove wall of the limiting groove and an outer peripheral wall of the sliding member is in an elastic deformable structure.

6. The massage chair according to claim 4, wherein the sliding member is a shaft sleeve rotatably sleeved on a pivot shaft, and the pivot shaft is connected to the first curve bar or to the second curve bar through a connecting member.

7. The massage chair according to claim 6, wherein a wear-resistant gasket is fitted between the limiting member and the connecting member, and the wear-resistant gasket is sleeved on the pivot shaft.

8. The massage chair according to claim 2, wherein A is defined as a rotation axis of relative rotation of the body with the first curved bar, B is defined as a rotation axis of relative rotation of the side panel with the first curved bar, C is defined as a rotation axis of relative rotation of the side panel with the second curved bar, D is defined as a rotation axis of relative rotation of the body with the second curved bar, and L is defined as a distance between A, B, C and D, wherein L_{AD}+L_{CD}>L_{BC}+L_{AB}.

9. The massage chair according to claim 8, wherein L_{CD}>L_{AB}, L_{BC}>L_{AD}, and at an initial position, an included angle between DA and DC is greater than 175 degrees, and an included angle between BA and BC is less than 175 degrees.

10. The massage chair according to claim 8, wherein, in a process of the side panel swinging backward after being moved outward from the initial position of the side panel, a rotation angle of the rotation axis B is greater than a rotation angle of the rotation axis C, wherein, when the side panel swinging backward to a rearmost positon, the rotation axis B is closer to the body than the rotation axis C.
